(19) United States
(12) Patent Application Publication
(10) Pub. No.: US 2026/0369228 A1
(43) Pub. Date: Nov. 19, 2026

(54) High Resolution Display Circuitry For Improving Luminance Uniformity

(71) Applicant: Apple Inc., Cupertino, CA (US)

(72) Inventors: Alper Ozgurluk, Sunnyvale, CA (US); Chun-Yao Huang, San Jose, CA (US); Cheuk Chi Lo, Belmont, CA (US); Cheng-Ho Yu, Milpitas, CA (US); Robert K. Kong, San Francisco, CA (US); Jenny Hu, Sunnyvale, CA (US); Chun-Ming Tang, Saratoga, CA (US); Andrew Lin, San Jose, CA (US); Hyun H. Boo, Santa Clara, CA (US); Won Kyu Ha, San Diego, CA (US); Vamsi R. Mocherla, Milpitas, CA (US); Shungneng Lee, Sunnyvale, CA (US)

(21) Appl. No.: 19/536,711

(22) Filed: Feb. 11, 2026

Related U.S. Application Data
(60) Provisional application No. 63/806,365, filed on May 15, 2025.

(51) Int. Cl. G09G 3/3233; G09G 3/32; G09G 3/3258; G09G 3/3291

(52) U.S. Cl. CPC G09G 3/3233; G09G 3/32; G09G 3/3258; G09G 3/3291; G09G 2300/0819; G09G 2300/0842; G09G 2300/0861; G09G 2310/08

(57) ABSTRACT

A display may include an array of pixels. Each pixel can include a light-emitting diode, a drive transistor, and a select transistor. The light-emitting diode has a cathode configured to receive a cathode voltage. During an emission phase, and the cathode voltage is driven to a first voltage level. During a data programming phase, the cathode voltage is driven to a second voltage level greater than the first voltage level to suppress leakage through the light-emitting diode. A global anode reset operation can be performed after the data programming phase and before the emission phase by activating an anode reset transistor in each pixel across the array. The anode reset transistor can receive a reset voltage biased at a predetermined voltage level during the global anode reset operation. The predetermined voltage level can be adjusted based on a current refresh rate of the display.

This application claims the benefit of U.S. Provisional Patent Application No. 63/806,365, filed May 15, 2025, which is hereby incorporated by reference herein in its entirety.

### BACKGROUND

This relates generally to electronic devices with displays and, more particularly, to display driver circuitry for displays such as organic light-emitting diode (OLED) displays.

Electronic devices often include displays. For example, portable computers typically include displays for presenting image content to users. OLED displays have an array of display pixels based on light-emitting diodes. In this type of display, each display pixel includes a light-emitting diode and associated transistors for controlling application of data signals to the light-emitting diode to produce light. It can be challenging to design high resolution OLED displays.

### SUMMARY

An electronic device may include a display having an array of display pixels. At least one of the display pixels can include a light-emitting diode having an anode terminal and a cathode terminal, a drive transistor coupled to the anode terminal, and a select transistor coupled to a gate terminal of the drive transistor. During an emission phase, the drive transistor is configured to pass a drive current through the light-emitting diode and a cathode voltage at the cathode terminal has a first voltage level. During a data programming phase, the select transistor is configured to pass a data signal onto the gate terminal of the drive transistor and the cathode voltage at the cathode terminal has a second voltage level greater than the first voltage level to suppress leakage through the light-emitting diode. The display pixel can further include an emission transistor that is activated during the emission phase and deactivated during the data programming phase. The display pixel can further include a first capacitor having a first terminal coupled to the gate terminal of the drive transistor and having a second terminal coupled to the anode terminal and a second capacitor having a first terminal coupled to the anode terminal and a second terminal configured to receive a fixed voltage that is separate from the positive power supply voltage. The display pixel can further include an anode reset transistor having a first source-drain terminal coupled to the anode terminal, a gate terminal configured to receive a reset control signal, and a second source-drain terminal coupled to a reset voltage line on which a reset voltage is provided, wherein the anode reset transistor and the select transistor are activated during an initialization phase preceding the compensation phase.

An aspect of the disclosure provides a method of operating a display having an array of pixels, wherein each pixel in the array includes a light-emitting diode, an emission transistor, and a drive transistor coupled in series between the emission transistor and the light-emitting diode. The method includes sequentially activating rows of pixels in the array to load data signals into the array during a data programming phase, simultaneously activating the emission transistor in each pixel across the array during an emission phase and performing a global anode reset operation to reset an anode of the light-emitting diode in each pixel across the array to a predetermined voltage level prior to the emission phase. Each pixel in the array can further includes a select transistor that is activated during the data programming phase and an anode reset transistor that is activated during the global anode reset operation.

The method can include simultaneously activating the anode reset transistor and the select transistor in each pixel across the array during a global initialization phase and simultaneously activating the select transistor and the emission transistor in each pixel across the array during a global compensation phase. The anode reset transistor in each pixel across the array can be configured to receive a reset voltage set to the predetermined voltage level during the data programming phase and the global anode reset operation and an additional voltage level different than the predetermined voltage level during at least the global initialization phase. The method can further include driving a cathode voltage on a cathode of the light-emitting diode to a first voltage level during the emission phase and suppressing leakage through the light-emitting diode in each pixel across the array by driving the cathode voltage to a second voltage level greater than the first voltage level during at least the data programming phase.

An aspect of the disclosure provides a display operable at a first refresh rate and a second refresh rate. The display includes an array of pixels, each of which includes a light-emitting diode, an emission transistor, a drive transistor coupled between the emission transistor and the light-emitting diode, a select transistor coupled to a gate terminal of the drive transistor, an anode reset transistor coupled to an anode of the light-emitting diode, a first capacitor coupled between the gate terminal of the drive transistor and the anode, and a second capacitor coupled between the anode and a voltage line on which a fixed voltage is provided. When the display is configured to operate at the first refresh rate, the anode reset transistor is configured to receive, during a global anode reset operation, a reset voltage driven to a first voltage level. When the display is configured to operate at the second refresh rate, the anode reset transistor is configured to receive, during the global anode reset operation, the reset voltage driven to a second voltage level different than the first voltage level to compensate for slow charging at the anode and other non-idealities.

### BRIEF DESCRIPTION OF THE DRAWINGS

FIG. 1 is a diagram of an illustrative electronic device having a display in accordance with some embodiments.

FIG. 2 is a diagram of an illustrative display having an array of organic light-emitting diode display pixels in accordance with some embodiments.

FIG. 3 is a circuit diagram of an illustrative display pixel in accordance with some embodiments.

FIG. 4 is a timing diagram showing an illustrative operation of a display pixel using a dynamically adjustable cathode voltage in accordance with some embodiments.

FIG. 5 is a plot showing anode voltage levels at the onset of emission for display pixels having drive transistors of different threshold voltages.

FIG. 6 is a plot illustrating luminance variation that can result from the drive transistors of different threshold voltages.

FIG. 7 is a timing diagram showing an illustrative operation of a display pixel using a post data programming anode reset in accordance with some embodiments.

FIG. 8 is a plot showing how the anode reset operation of FIG. 7 can equalize the anode voltage for different display pixels to one voltage level in accordance with some embodiments.

FIG. 9 is a plot illustrating luminance uniformity that can be achieved using the anode reset operation shown in FIG. 7 in accordance with some embodiments.

FIG. 10 is a diagram showing at least two display modes for operating a display of the type shown in connection with FIGS. 1-9 in accordance with some embodiments.

FIG. 11 is a plot showing how luminance can vary at low gray levels between different display modes in accordance with some embodiments.

FIG. 12 is a timing diagram showing an illustrative operation of a display pixel using a dynamically adjustable reset voltage in accordance with some embodiments.

### DETAILED DESCRIPTION

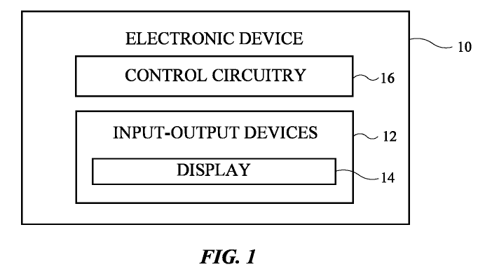

An illustrative electronic device of the type that may be provided with a display is shown in FIG. 1. As shown in FIG. 1, electronic device 10 may have control circuitry 16. Control circuitry 16 may include storage and processing circuitry for supporting the operation of device 10. The storage and processing circuitry may include storage such as hard disk drive storage, nonvolatile memory (e.g., flash memory or other electrically-programmable-read-only memory configured to form a solid state drive), volatile memory (e.g., static or dynamic random-access-memory), etc. Processing circuitry in control circuitry 16 may be used to control the operation of device 10. The processing circuitry may be based on one or more microprocessors, application processors, microcontrollers, digital signal processors, baseband processors, power management units, audio chips, application specific integrated circuits, etc.

Input-output circuitry in device 10 such as input-output devices 12 may be used to allow data to be supplied to device 10 and to allow data to be provided from device 10 to external devices. Input-output devices 12 may include buttons, joysticks, scrolling wheels, touch pads, key pads, keyboards, microphones, speakers, tone generators, vibrators, cameras, sensors, light-emitting diodes and other status indicators, data ports, etc. A user can control the operation of device 10 by supplying commands through input-output devices 12 and may receive status information and other output from device 10 using the output resources of input-output devices 12.

Input-output devices 12 may include one or more displays such as display 14. Display 14 may be a touch screen display that includes a touch sensor for gathering touch input from a user or display 14 may be insensitive to touch. A touch sensor for display 14 may be based on an array of capacitive touch sensor electrodes, acoustic touch sensor structures, resistive touch components, force-based touch sensor structures, a light-based touch sensor, or other suitable touch sensor arrangements.

Control circuitry 16 may be used to run software on device 10 such as operating system code and applications. During operation of device 10, the software running on control circuitry 16 may display images on display 14 using an array of pixels in display 14. Device 10 may be a tablet computer, laptop computer, a desktop computer, a display, a cellular telephone, a media player, a wristwatch device or other wearable electronic equipment, a head-mounted device, eyewear, or other suitable electronic device.

Display 14 may be an organic light-emitting diode display or may be a display based on other types of display technology. Configurations in which display 14 is an organic light-emitting diode (OLED) display are sometimes described herein as an example. This is, however, merely illustrative. Any suitable type of display may be used in device 10, if desired.

Display 14 may have a rectangular shape (i.e., display 14 may have a rectangular footprint and a rectangular peripheral edge that runs around the rectangular footprint) or may have other suitable shapes. Display 14 may be planar or may have a curved profile.

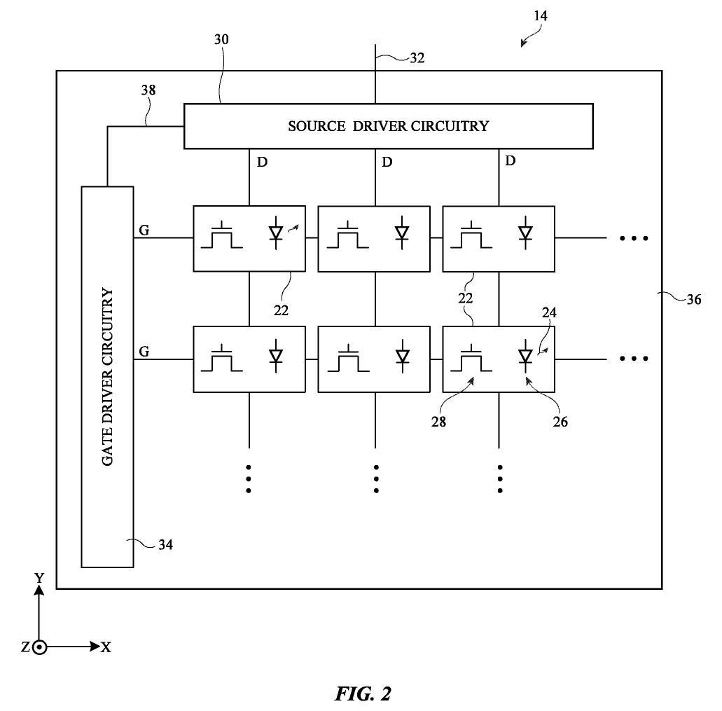

A top view of a portion of display 14 is shown in FIG. 2. As shown in FIG. 2, display 14 may have an array of pixels 22 formed on a substrate 36. Substrate 36 may be formed from glass, metal, plastic, ceramic, porcelain, silicon, or other substrate materials. Pixels 22 may receive data signals over signal paths such as data lines D (sometimes referred to as data signal lines, column lines, etc.) and may receive one or more control signals over control signal paths such as horizontal control lines G (sometimes referred to as gate lines, scan lines, emission lines, row lines, etc.). There may be any suitable number of rows and columns of pixels 22 in display 14 (e.g., tens or more, hundreds or more, or thousands or more).

Each pixel 22 may have a light-emitting diode 26 that emits light 24 under the control of a pixel control circuit formed from transistor circuitry. Transistors 28 can include bulk silicon transistors or thin-film transistors such as polysilicon thin-film transistors, semiconducting oxide thin-film transistors such as indium zinc gallium oxide transistors, or thin-film transistors formed from other semiconductors. Pixels 22 may contain light-emitting diodes of different colors (e.g., red, green, blue, white, or other colors) to provide display 14 with the ability to display color images.

Source driver circuitry 30 may be used to control the operation of pixels 22. The source driver circuitry 30 may be formed from integrated circuits, thin-film transistor circuits, or other suitable electronic circuitry. Source driver circuitry 30 of FIG. 2 may contain communications circuitry for communicating with system control circuitry such as control circuitry 16 of FIG. 1 over path 32. Path 32 may be formed from traces on a flexible printed circuit or other cable. During operation, the control circuitry (e.g., control circuitry 16 of FIG. 1) may supply circuitry 30 with information on images to be displayed on display 14.

To display the images on display pixels 22, source driver circuitry 30 may supply image data to data lines D (e.g., data lines that run down the columns of pixels 22) while issuing clock signals and other control signals to supporting display driver circuitry such as gate driver circuitry 34 over path 38. If desired, source driver circuitry 30 may also supply clock signals and other control signals to gate driver circuitry 34 on an opposing edge of display 14 (e.g., the gate driver circuitry may be formed on more than one side of the display pixel array).

Gate driver circuitry 34 (sometimes referred to as horizontal line control circuitry or row driver circuitry) may be implemented as part of an integrated circuit and/or may be implemented using thin-film transistor circuitry. Horizontal/row control lines G in display 14 may carry gate line signals (scan line control signals), emission enable control signals, and/or other horizontal control signals for controlling the pixels of each row. The row control lines G are therefore sometimes referred to as gate lines. There may be any suitable number of horizontal control signals per row of pixels 22 (e.g., one or more row control lines, two or more row control lines, three or more row control lines, four or more row control lines, five or more row control lines, etc.).

Certain applications require displays with high contrast ratio and high resolution. Displays such as organic light-emitting diode (OLED) displays can provide high resolution and high contrast ratio. Display pixels in an OLED display can include thin-film transistors that are subject to threshold voltage variation. Variations in transistor threshold voltages can result in non-uniformity in pixel-to-pixel luminance across an array of display pixels. To provide a high contrast ratio while ensuring sufficient pixel-to-pixel luminance uniformity, in-pixel (internal) threshold voltage compensation techniques can be employed. Conventional pixel architectures that support internal threshold voltage compensation, however, include a large number of thin-film transistors, which limits the maximum achievable resolution of the display. For instance, a conventional OLED pixel that supports in-pixel threshold voltage compensation typically includes seven or more transistors coupled to a light-emitting diode.

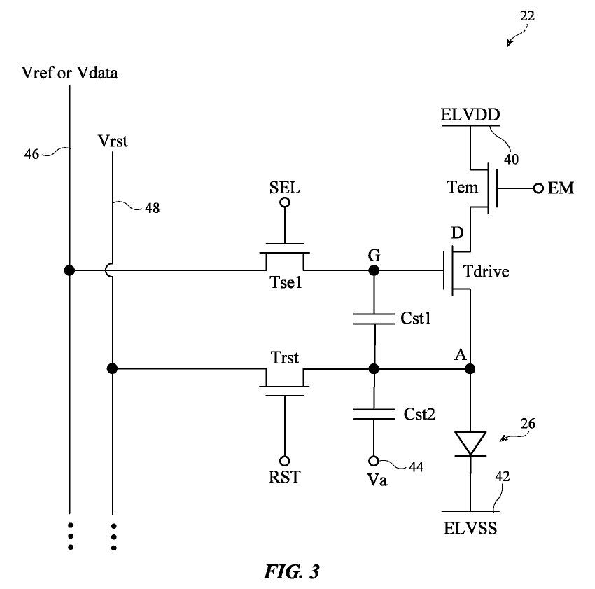

In accordance with an embodiment, FIG. 3 is a circuit diagram of an illustrative organic light-emitting diode (OLED) display pixel 22 with a reduced transistor count while still being able to support in-pixel (internal) threshold voltage compensation. As shown in FIG. 3, display pixel 22 includes only four thin-film transistors such as transistors Tdrive, Tem, Tsel, and Trst, two capacitors such as storage capacitors Cst1 and Cst2, and an organic light-emitting diode 26. Transistors Tdrive, Tem, Tsel, and Trst can be n-type semiconducting oxide transistors. Semiconducting oxide transistors are defined as thin-film transistors having a channel region formed from semiconducting oxide material (e.g., indium gallium zinc oxide or IGZO, indium tin zinc oxide or ITZO, indium gallium tin zinc oxide or IGTZO, indium tin oxide or ITO, or other semiconducting oxide material).

A semiconducting oxide transistor is notably different than a thin-film silicon transistor (i.e., a transistor having a polysilicon channel region deposited using a low temperature process sometimes referred to as LTPS or low-temperature polysilicon). Semiconducting oxide transistors exhibit relatively lower leakage than silicon transistors, so implementing at least some of the transistors within pixel 22 can help reduce flicker and luminance non-uniformity (e.g., by preventing current from leaking away from the gate terminal of transistor Tdrive). If desired, at least some of the transistors within pixel 22 may be implemented as silicon transistors such that pixel 22 has a hybrid configuration that includes a combination of semiconducting oxide transistors and silicon transistors (e.g., n-type LTPS transistors or p-type LTPS transistors). In other embodiments, all of the transistors within display pixel 22 are implemented as silicon transistors (e.g., n-type LTPS transistors).

Transistor Tdrive (sometimes referred to herein as a “drive transistor”) may have a drain terminal, a gate terminal coupled to node G, and a source terminal coupled to an anode terminal A of light-emitting diode 26. Although not explicitly shown, each transistor in pixel 22 can further include a back gate terminal. The gate terminal shown for each transistor in pixel 22 may represent a top gate terminal. For transistor Tdrive, the back gate terminal may be shorted to its source terminal. For at least some other transistors within pixel 22, the top and back gate terminals can be shorted together. The terms “source” and “drain” are sometimes used interchangeably when referring to current-conducting terminals of a thin-film transistor. The source and drain terminals are therefore sometimes referred to as “source-drain” terminals (e.g., a transistor has a gate terminal, a first source-drain terminal, and a second source-drain terminal). For instance, the drain terminal of transistor Tdrive can be referred to as a first source-drain terminal, and the source terminal of transistor Tdrive can be referred to as a second source-drain terminal, or vice versa. First storage capacitor Cst1 may be coupled across the gate and source terminals of transistor Tdrive and may be configured to store a data value for display pixel 22.

The term “activate” with respect to a switch (or transistor) may refer to or be defined herein as an action that places the switch in an “on”or low-impedance state such that the two terminals of the switch are electrically connected to conduct current. Activating a switch can sometimes be referred to as turning on or closing a switch. The term “deactivate” with respect to a switch (or transistor) may refer to or be defined herein as an action that places the switch in an “off” or high-impedance state such that the two terminals of the switch/transistor are electrically disconnected with minimal leakage current. Deactivating a switch can sometimes be referred to as turning off or opening a switch.

Transistor Tem (sometimes referred to as an emission transistor) may have a source terminal coupled to the drain terminal of transistor Tdrive, a drain terminal coupled to a positive power supply line 40 (e.g., a positive power supply line on which positive supply voltage ELVDD is provided), and a gate terminal configured to receive an emission (control) signal EM. Pixel positive power supply voltage ELVDD may be 3 V, 4 V, 5 V, 6 V, 7 V, 2 to 8 V, greater than 6 V, greater than 7 V, greater than 8 V, greater than 10 V, greater than 12 V, 6-12 V, 12-20 V, or other suitable positive power supply voltage level. Display pixel 22 has only one emission transistor.

Light-emitting diode 26 may have anode terminal A coupled to the source terminal of drive transistor Tdrive and a cathode terminal coupled to a ground power supply line 42 (e.g., a ground line on which ground power supply voltage ELVSS is provided). Ground power supply voltage ELVSS may be 0 V, -1 V, -2 V, -3 V, -4 V, -5 V, -6V, -7 V, -8 V, -9 V, less than 2 V, less than 1 V, less than 0 V, less than -5 V, or other suitable ground, negative, or low power supply voltage level. Connected in this way, transistors Tem and Tdrive are considered to be connected “in series” with light-emitting diode 26.

Light-emitting diode 26 may have an associated parasitic capacitance, which can vary from pixel-to-pixel and change over its lifetime. The size of the diode parasitic capacitance, relative to the storage capacitance Cst1, can affect the amount of applied data voltage appearing across transistor Tdrive and can thus affect the amount of drive current flowing through the drive transistor into diode 26, which directly impacts the luminance of each display pixel 22. To help mitigate the effects of variance of the diode parasitic capacitance across the pixel array, each display pixel 22 can be provided with a second storage capacitor Cst2 coupled between the anode terminal of diode 26 and a voltage line 44. Capacitor Cst2 may, for example, be sized larger than the diode parasitic capacitance. Connected in this way, capacitor Cst2 can help mitigate the variation in the diode parasitic capacitance, which can help enhance pixel-to-pixel luminance uniformity. Capacitor Cst2 can also help extend the data range by capacitively coupling with Cst1. Connected in this way, only part of the applied Vdata appears across the gate and source nodes of the drive transistor. A larger data range helps to relieve some burden on source driver circuitry 30 by increasing the gray level step size.

Voltage line 44 may be configured to receive a fixed DC (direct current) voltage Va. The fixed (static) voltage Va may be a cleaner signal that fluctuates less than ELVDD on power supply line 40. Fixed voltage Va may thus be separate from ELVDD and ELVSS. Coupling capacitor Cst2 to DC voltage Va rather than to power supply voltage ELVDD can thus help reduce any content-dependent artifacts that would otherwise be coupled onto the anode terminal or onto the gate terminal of transistor Trive. Moreover, connecting capacitor Cst2 to a separate voltage line also enables optimization of the voltage swing across capacitor Cst2. In certain embodiments, capacitors Cst1 and Cst2 are implemented using a relatively thin dielectric layer that is prone to voltage breakdown. Using a separate voltage Va to bias capacitor Cst2 allows selection of Va to be in the middle of the voltage swing range experienced by the storage capacitors, which can help prevent high voltage breakdown. The use of capacitor Cst2 in display pixel 22 is optional.

Transistor Tsel (sometimes referred to herein as a select transistor, a switching transistor, a gate voltage initialization transistor, or a pass transistor) may have a first source-drain terminal coupled to the gate terminal of transistor Tdrive, a second source-drain terminal coupled to a control voltage line 46, and a gate terminal configured to receive a select control (scan) signal SEL. Transistor Tsel may serve as a dual purpose switch. During initialization and compensation phases, transistor Tsel may be used to apply a reference voltage Vref provided on control (adjustable) voltage line 46 to the drive transistor. During a programming phase (e.g., during a data loading phase), transistor Tsel may be used to apply a data voltage Vdata provided on voltage line 46 to the drive transistor. Voltage line 46 can therefore sometimes be referred to as a reference line, a data line, or a dual purpose reference/data line. In the example of FIG. 3, pixel 22 includes only one transistor Tsel coupled at the gate terminal of transistor Tdrive.

Transistor Trst (sometimes referred to herein as a reset transistor or an anode reset transistor) may have a first source-drain terminal coupled to anode terminal A, a second source-drain terminal coupled to a reset voltage line 48, and a gate terminal configured to receive a reset control (scan) signal RST. A reset voltage Vrst may be provided on voltage line 48. Signal RST can be asserted (e.g., driven high) to selectively activate reset transistor Trst and can be deasserted (e.g., driven low) to selectively deactivate reset transistor Trst. When transistor Trst is activated, transistor Trst will drive the anode terminal to reset voltage Vrst (e.g., transistor Trst will reset the anode terminal of diode 26). The control signals SEL and RST being provided to the gate terminals of transistors Tsel and Trst, respectively, are sometimes referred to collectively as scan signals or gate line signals.

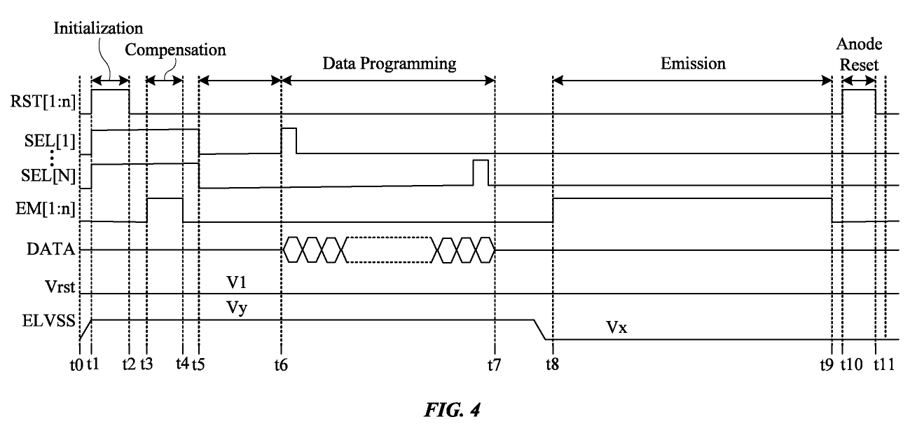

FIG. 4 is a timing diagram showing illustrative waveforms involved in operating the display pixel 22 of the type described in connection with FIG. 3. Signal RST[1:n] may represent the reset control signals for controlling transistors Trst in all n pixel rows, where n can be an integer with a value of greater than 100 or greater than 1000 (e.g., display 14 can include hundreds or thousands of pixel rows). Signal SEL[1] may represent the select control signal for controlling transistors Tsel in the first pixel row of the array, whereas signal SEL[n] may represent the select control signal for controlling transistors Tsel in the n^{th} (last) pixel row of the array. Signal EM[1:n] may represent the emission control signals for controlling transistors Tem in all n pixel rows of the array. The reset voltage Vrst on voltage line 48 can have a fixed voltage level of V1 (as an example). At time t0, all of the signals can be deasserted (e.g., driven low).

At time t1, signals RST[1:n] and SEL[1:n] can be asserted (e.g., pulsed high). Signal SEL[1:n] may represent the select control signals for controlling transistors SEL in all n pixel rows. Asserting signals RST[1:n] and SEL[1:n] simultaneously activates all transistors Tsel and Trst across the pixel array, thereby performing a “global” initialization operation where all rows are concurrently initialized. The time period from time t1 to t2 is thus sometimes referred to as a global initialization phase. During the initialization phase, a reference voltage Vref may be provided on all of the voltage lines 46 across the array. At the end of the initialization phase, signals RST[1:n] are deasserted.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

From time t3 to time t4, signals EM[1:n] can be simultaneously pulsed high. Asserting signals EM[1:n] can activate all transistors Tem across the entire pixel array, thereby performing a “global” compensation operation where the drive transistor threshold voltage of all pixels 22 in the array are concurrently sampled. Such compensation operation is thus sometimes referred to as a threshold voltage sampling operation. The time period from time t3 to t4 is thus sometimes referred to as a global compensation phase or a global threshold voltage sampling phase. During the compensation phase, signals SEL[1:n] remain asserted to activate all of the select transistors Tsel to pass reference voltage Vref onto corresponding gate terminals of transistors Tdrive. At the end of the compensation phase, signals EM[1:n] are deasserted. Sometime later, at time t5, signals SEL[1:n] can be deasserted.

From time t5 to t6, all signals may remain idle to provide some timing margin between the compensation phase and the ensuing data programming phase. The time period from time t6 to t7 may be referred to as a data programming or data loading phase. During the data programming phase, data signals can be sequentially loaded into successive pixel rows in the array by pulsing the SEL signals one row at a time (e.g., by first pulsing signal SEL[1], then pulsing signal SEL[2], then pulsing signal SEL[3], and so on until finally pulsing signal SEL[n] towards the end of the data programming phase). During the data programming phase, source driver circuitry 30 (FIG. 2) may output corresponding data signals on voltage lines 46.

From time t8 to time t9, only signals EM[1:n] can be simultaneously pulsed high while all other signals remain deasserted. Doing so activates all of the emission transistors Tem across the pixel array, thereby allowing drive currents proportional to the loaded data signals to flow through respective diodes 26 to emit light. The time period from time t8 to t9 may be referred to as an emission phase. After the emission phase, a global anode reset operation can optionally be performed from time t10 to time t11. The time period from time t10 to t11 can thus sometimes be referred to as a global anode reset, global reset phase, or “post-emission” anode reset phase. During the post-emission anode reset phase, signals RST[1:n] can be simultaneously pulsed high to activate all of transistors Trst across the entire array. Resetting the anodes of all diodes 26 in this way can ensure that all diodes 26 across the array are sufficiently deactivated to prevent further emission after the emission phase and also to improve luminance uniformity across the display panel.

In display pixel 22 of the type shown in FIG. 3, the drive transistor Tdrive is directly connected to the anode of diode 26. Conventional pixel circuits often include an additional emission transistor coupled between the drive transistor and the light-emitting diode. Such additional emission transistor can help decouple the drive transistor from the light-emitting diode, thus ensuring that the anode voltage remains low prior to the emission phase. Without such additional emission transistor as in the case of pixel 22, it is possible for the voltage at anode A to begin rising after the initialization phase. For example, if care is not taken, the anode voltage (e.g., the voltage at anode terminal A) of pixel 22 can begin rising after time t2 in FIG. 4. Such rising anode voltage prior to the emission phase can lead to OLED leakage and early OLED turn-on (i.e., the OLED prematurely emitting light before the start of the emission phase), which can result in panel non-uniformity in the form of visible vertical gradients in the global emission.

To prevent such OLED leakage and early turn-on, the cathode terminal of diode 26 can be toggled to a higher voltage in accordance with some embodiments. This is illustrated in the timing of FIG. 4 where the ELVSS voltage at the cathode terminal is raising from the ground voltage level Vx to a higher voltage level Vy at time t0 before the start of the initialization phase. Voltage level Vx may represent the nominal ground voltage level, which can be 0 V or a negative voltage. In general, the ELVSS voltage can be raised from Vx to Vy any time before the start of the compensation phase. Voltage level Vy should be at least 1 V, 2 V, 3 V, 2-4 V, or more than 3 V greater than ground voltage level Vx.

Voltage ELVSS at the cathode terminal of diode 26 is sometimes referred to herein as the cathode voltage. Cathode voltage ELVSS may be a global voltage for biasing the cathode terminals of all pixels 22 in display 14. Cathode voltage ELVSS can be maintained at this elevated voltage level Vy throughout the compensation phase and the data programming phase and is lowered back to the nominal ground voltage level Vx before the start of the emission phase. Dynamically raising the cathode voltage in this way thus ensures that the voltage across the anode and cathode terminals of diode 26 is kept low even if the anode voltage rises. Dynamically toggling or raising the cathode voltage ELVSS between time t1 and t8 is thus technically advantageous and beneficial to mitigate and suppress any OLED leakage and early turn-on. Such time-varying ELVSS voltage as shown in FIG. 4 is sometimes referred to as a dynamically adjustable cathode voltage.

Another problem associated with pixel 22 of the type shown in FIG. 3 is that during the compensation phase, the threshold voltage sampling only adjusts the gate-to-source voltage (“Vgs”) of the drive transistor, but any variation in the threshold voltage of the drive transistor can lead to different anode voltages even after the compensation phase. In practice, the threshold voltage (“Vth”) of the drive transistors in pixels 22 can be different due to process variations resulting from manufacturing (fabrication) non-idealities.

FIG. 5 is a plot of anode voltage as a function of time for display pixels having varying drive transistor threshold voltages. Waveform 100 may represent the anode voltage for a first display pixel having a drive transistor of a first Vth. Waveform 102 may represent the anode voltage for a second display pixel having a drive transistor of a second Vth different from the first Vth. Waveform 104 may represent the anode voltage for a third display pixel having a drive transistor of a third Vth different from the first and second Vth. Waveforms 100, 102, and 104 all have different initial anode voltage levels at the onset of the emission phase (e.g., when curves 100, 102, and 104 all begin to ramp up at the same time). Due to the different initial anode voltage levels, waveform 100 will cross a diode turn-on voltage level Von at a first time t1, waveform 102 will cross the diode turn-on voltage level Von at a second time t2 after time t1, and waveform 104 will cross Von at a third time t3 after time t2.

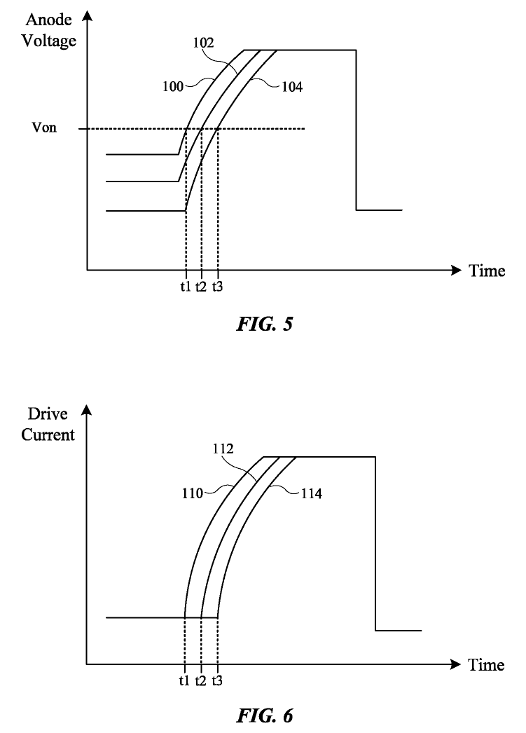

FIG. 6 is a plot of drive current as a function of time for the display pixels described in connection with FIG. 5. Here, “drive current” can refer to the amount of current flowing through the drive transistor Tdrive and into diode 26 during the emission phase. Waveform 110 may represent the drive current profile corresponding to the display pixel associated with waveform 100 of FIG. 5. Waveform 112 may represent the drive current profile corresponding to the display pixel associated with waveform 102 of FIG. 5. Waveform 114 may represent the drive current profile corresponding to the display pixel associated with waveform 104 of FIG. 5. As shown in FIG. 6, waveform 110 will begin ramping up at time t1, waveform 112 will begin ramping up at time t2, and waveform 114 will begin ramping up at time t3. Such difference in the timing of the drive current profiles can result in display panel luminance variation.

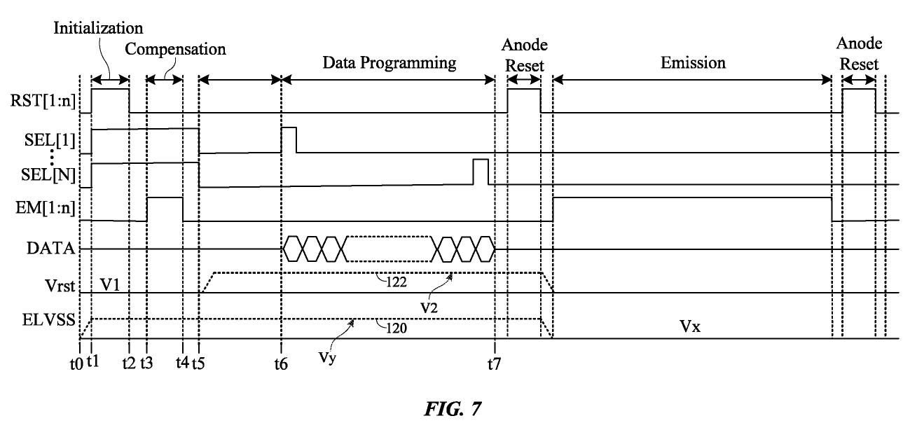

It is recognized herein that such luminance variation is due to the slow charging of the anode voltage, especially when the data signals are at low gray levels. Such slow charging at the anode terminal is a direct result of the relatively large capacitance of the two storage capacitors Cst1 and Cst2 directly connected to the anode terminal of diode 26. In accordance with an embodiment not mutually exclusive with the techniques described in connection with FIG. 4, an anode reset operation can be performed immediately before the emission phase (see, e.g., FIG. 7). As shown in FIG. 7, an additional global anode reset operation can be performed after the data programming phase and before the emission phase. During this anode reset phase, signals RST[1:n] may be pulsed high to simultaneously activate all of transistors Trst across the pixel array. Thus, the term “global” anode reset here can refer to an operation that resets all of the anodes across the entire pixel array. During the pixel operation shown in FIG. 7, the cathode voltage ELVSS may be kept at a constant ground voltage level Vx or can alternatively be dynamically raised to voltage level Vy, as shown by dotted waveform 120. Such global anode reset operation that is performed immediately prior to the emission phase is sometimes referred to herein as a “pre-emission” anode reset operation.

FIG. 8 is a plot showing how the global pre-emission anode reset operation of FIG. 7 can help equalize the anode voltage for different display pixels with varying Vth. As shown in FIG. 8, waveform 130 can represent the anode voltage for different pixels 22 all having different threshold voltages. Even for pixels 22 with different drive transistor threshold voltages, the anode reset waveforms are all driven to the same (predetermined) anode reset voltage level prior to time t1. Waveform 130 will cross diode turn-on voltage level Von at time t1.

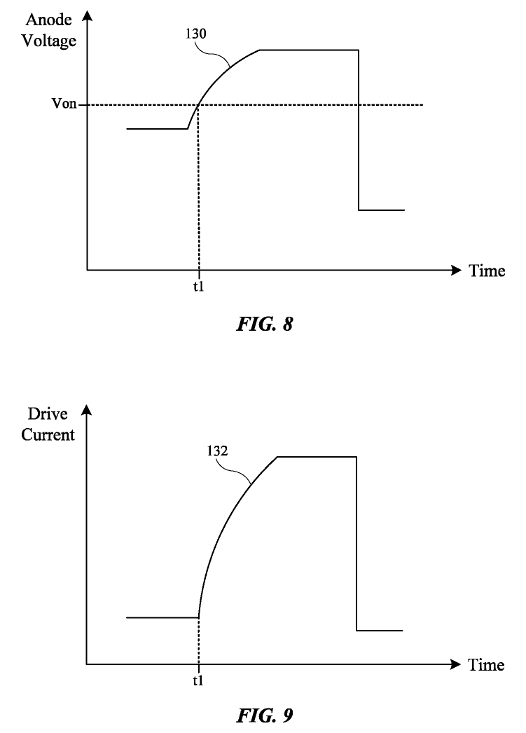

FIG. 9 is a plot of drive current as a function of time for the display pixels described in connection with FIG. 8. Waveform 132 may thus represent the drive current profile corresponding to the display pixels associated with waveform 130 of FIG. 8. As shown in FIG. 9, waveform 132 for different pixels 22 with varying drive transistor threshold voltages will ramp up simultaneously at time t1. Performing pre-emission anode reset in this way can therefore be technically advantageous and beneficial to reset all anode terminals to the same voltage level right before the emission phase, which synchronizes the OLED turn-on time for display pixels 22 with varying drive transistor threshold voltages and thus mitigates the slow charging problem associated pixel 22 and thus improves the panel luminance uniformity for all gray levels.

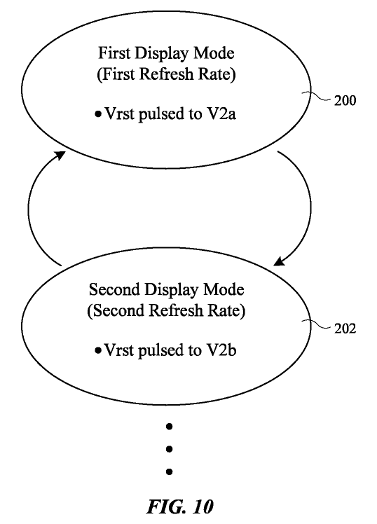

Display 14 described in connection with FIGS. 1-9 can be configured to operate in multiple display modes (see, e.g., FIG. 10). As shown in FIG. 10, display 14 can be configured to operate in at least a first display mode 200 and a second display mode 202. During first display mode 200, display 14 may be configured to operate using a first refresh rate. During second display mode 202, display 14 may be configured to operate using a second refresh rate different than the first refresh rate. As an example, the first refresh rate may be equal to 90 Hz, and the second refresh rate may be equal to 120 Hz. These refresh rates are exemplary. The first and second refresh rates of modes 200 and 202 can be any suitable display refresh rate. If desired, display 14 can be configured to operate in more than two display modes (e.g., to support operation at more than two different refresh rates).

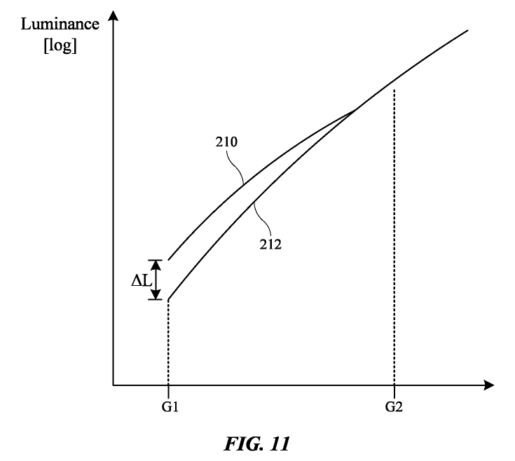

The refresh rate of a display can affect the duration of the display’s emission period. A lower refresh rate translates to a longer emission period, whereas a higher refresh rate translates to a shorter emission period. For example, a 90 Hz refresh rate might correspond to an emission period of 2.67 ms (milliseconds), whereas a 120 Hz refresh rate might correspond to a shorter (narrower) emission period of 2 ms. A user of display 14 perceives an average luminance, which is a function of the product of the refresh rate and the associated emission period. FIG. 11 is a plot showing average luminance (in log scale) as a function of a gray level of the data signals. Line 210 may represent the average luminance across different gray levels for a display operating at a first refresh rate R1, whereas line 212 may represent the average luminance across different gray levels for the display operating at a second refresh rate R2 different than R1. At high gray levels (e.g., around G2), the luminance of the display between the two refresh rates is approximately equal. At low(er) gray levels (e.g., around G1), however, the luminance of line 210 and the luminance of line 212 can exhibit a much larger (noticeable) difference, as indicated by luminance offset ΔL due to slow charging of the anode terminal. Such luminance offset, if not mitigated, can result in a perceivable flash to the user when switching from one refresh rate to a different refresh rate.

In accordance with another embodiment not mutually exclusive with the techniques described above in connection with FIGS. 1-10, display 22 may be configured to receive a reset voltage Vrst biased to different voltage levels depending on the current refresh rate of display 14. For example, when display 14 is operating at a 90 Hz refresh rate, voltage Vrst may be dynamically adjusted to a first reset voltage level V2a. When display 14 is operating at a 120 Hz refresh rate, voltage Vrst may be dynamically adjusted to a second reset voltage level V2b that is different than V2a. Reset voltage level V2b corresponding to the higher refresh rate display mode may be greater than reset voltage level V2a. A higher reset voltage level can help set the anode terminal to a relatively higher voltage prior to the emission phase, which mitigates the shorter charging time that is available for the higher refresh rate operation.

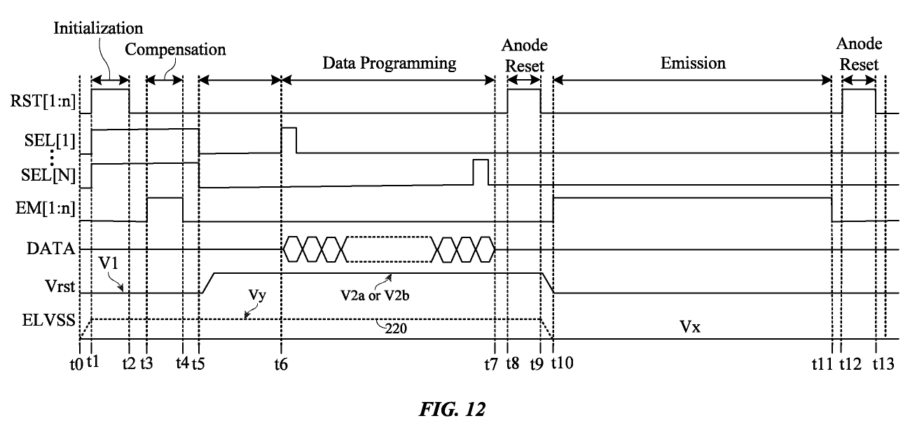

FIG. 12 is a timing diagram illustrating such technique for dynamically varying the reset voltage level based on the current display refresh rate. At time t0, all of the signals can be deasserted (e.g., driven low). The reset voltage Vrst may be set to a nominal low reset voltage level V1. If desired, the cathode voltage can be set at the nominal ground voltage Vx or can alternatively be raised to voltage level Vy at time t0, as shown by dotted waveform 220, to help suppress OLED leakage and early turn-on.

At time t1, signals RST[1:n] and SEL[1:n] can be asserted (e.g., pulsed high). Signal SEL[1:n] may represent the select control signals for controlling transistors SEL in all n pixel rows. Asserting signals RST[1:n] and SEL[1:n] simultaneously activates all transistors Tsel and Trst across the pixel array, thereby performing a “global” initialization operation where all rows are concurrently initialized. The time period from time t1 to t2 is thus sometimes referred to as a global initialization phase. During the initialization phase, a reference voltage Vref may be provided on all of the voltage lines 46 across the array. At the end of the initialization phase, signals RST[1:n] are deasserted.

From time t3 to time t4, signals EM[1:n] can be simultaneously pulsed high. Asserting signals EM[1:n] can activate all transistors Tem across the entire pixel array, thereby performing a “global” compensation operation where the drive transistor threshold voltage of all pixels 22 in the array are concurrently sampled. Such compensation operation is thus sometimes referred to as a threshold voltage sampling operation. The time period from time t3 to t4 is thus sometimes referred to as a global compensation phase or a global threshold voltage sampling phase. During the compensation phase, signals SEL[1:n] remain asserted. At the end of the compensation phase, signals EM[1:n] are deasserted. Sometime later, at time t5, signals SEL[1:n] can be simultaneously deasserted.

At time t5, reset voltage Vrst can be raised from voltage level V1 to either V2a or V2b. Voltage levels V2a and V2b can be at least 1 V, 2 V, 3 V, 4 V, 5 V, 3-5 V, 2-6 V, more than 4 V, or more than 5 V greater than nominal reset voltage level V1. Reset voltage Vrst can be raised to V2a if display 14 is currently operating in first display mode 200 or can be raised to V2b if display 14 is currently operating in second display mode 202. Voltage level V2b is different than voltage level V2a. Assuming that the second display mode 202 is associated with a higher refresh rate, then voltage level V2b will be higher than voltage level V2a. Voltage level V2b can be at least 0.3 V, 0.5 V, 0.5-1 V, more than 1 V, more than 1.5 V, or more than 2 V greater than V2a. If desired, such dynamic toggling of Vrst can also be applied to the operation described in connection with FIG. 7 (see, e.g., dotted waveform 122).

From time t5 to t6, all signals may remain idle to provide some timing margin between the compensation phase and the ensuing data programming phase. The time period from time t6 to t7 may be referred to as a data programming or data loading phase. During the data programming phase, data signals can be sequentially loaded into successive pixel rows in the array by pulsing the SEL signals one row at a time (e.g., by first pulsing signal SEL[1], then pulsing signal SEL[2], then pulsing signal SEL[3], and so on until finally pulsing signal SEL[n] towards the end of the data programming phase). During the data programming phase, source driver circuitry 30 (FIG. 2) may output corresponding data signals on voltage lines 46.

From time t8 to time t9, signals RST[1:n] may be simultaneously pulsed high to perform a pre-emission anode reset operation. The time period from time t8 to t9 is therefore sometimes referred to as the pre-emission anode reset phase. During the pre-emission anode reset phase, all of transistors Trst across the pixel array are globally (simultaneously) activated to reset the anode voltage of all pixels 22 to either V2a (if display 14 is currently operating at the first refresh rate) or V2b (if display 14 is currently operating at the second refresh rate). Dynamically adjusting reset voltage Vrst to different voltage levels (e.g., V2a, V2b, or other voltage levels if there are additional refresh rates) can therefore help mitigate the luminance offset ΔL described in connection with FIG. 11 between the different refresh rates, thus ensuring uniform luminance across multiple refresh rates for display 14. At time t9, signals RST[1:n] can be deasserted. At time t9, the reset voltage Vrst can be lowered from either V2a or V2b back down to the nominal reset voltage level V1.

From time t10 to t11, only signals EM[1:n] can be simultaneously pulsed high while all other signals remain deasserted. Doing so activates all of the emission transistors Tem, thereby allowing drive currents proportional to the loaded data signals to flow through respective diodes 26 to emit light. After the emission phase, a global anode reset operation can optionally be performed from time t12 to time t13. The time period from time t12 to t13 can thus sometimes be referred to a “post-emission” anode reset phase. During the post-emission anode reset phase, signals RST[1:n] can be simultaneously pulsed high to activate all of transistors Trst across the entire array. Globally resetting the anodes of all diodes 26 in this way can ensure that all diodes 26 across the array are sufficiently deactivated to prevent further emission after the emission phase.

The foregoing is merely illustrative and various modifications can be made to the described embodiments. The foregoing embodiments may be implemented individually or in any combination.

What is claimed is:

1. A display pixel comprising:
a light-emitting diode having an anode terminal and a cathode terminal;
a drive transistor coupled to the anode terminal; and
a select transistor coupled to a gate terminal of the drive transistor, wherein:
during an emission phase, the drive transistor is configured to pass a drive current through the light-emitting diode and a cathode voltage at the cathode terminal has a first voltage level; and
during a data programming phase, the select transistor is configured to pass a data signal onto the gate terminal of the drive transistor and the cathode voltage at the cathode terminal has a second voltage level greater than the first voltage level to suppress leakage through the light-emitting diode.

2. The display pixel of claim 1, further comprising:
an emission transistor having a first source-drain terminal configured to receive a positive power supply voltage, a second source-drain terminal coupled to the drive transistor, and a gate terminal configured to receive an emission control signal, wherein the emission transistor is activated during the emission phase and is deactivated during the data programming phase.

3. The display pixel of claim 2, further comprising:
a first capacitor having a first terminal coupled to the gate terminal of the drive transistor and having a second terminal coupled to the anode terminal; and
a second capacitor having a first terminal coupled to the anode terminal and a second terminal configured to receive a fixed voltage that is separate from the positive power supply voltage.

4. The display pixel of claim 3, wherein during a compensation phase, the select transistor is activated to pass a reference voltage onto the gate terminal of the drive transistor, and wherein the emission transistor is also activated during the compensation phase.

5. The display pixel of claim 4, further comprising:
an anode reset transistor having a first source-drain terminal coupled to the anode terminal, a gate terminal configured to receive a reset control signal, and a second source-drain terminal coupled to a reset voltage line on which a reset voltage is provided, wherein the anode reset transistor and the select transistor are activated during an initialization phase preceding the compensation phase.

6. The display pixel of claim 5, wherein:
during the compensation phase, the cathode voltage is at the second voltage level; and
the second voltage level is at least 1 V greater than the first voltage level.

7. The display pixel of claim 5, wherein:
after the data programming phase and before the emission phase, the anode reset transistor is activated to perform an anode reset operation to reset the anode terminal to a predetermined voltage level prior to the emission phase.

8. The display pixel of claim 7, wherein:
the anode reset transistor is configured to receive the reset voltage driven to a third voltage level during the initialization phase; and
the anode reset transistor is configured to receive the reset voltage driven to the predetermined voltage level, greater than the third voltage level, during the anode reset operation.

9. The display pixel of claim 7, wherein:
following the emission phase, only the anode reset transistor is activated to perform an additional anode reset operation to reset the anode terminal to the third voltage level.

10. The display pixel of claim 7, wherein:
the display pixel is configured to operate in accordance with at least a first refresh rate or a second refresh rate greater than the first refresh rate;
when the display pixel is configured to operate at the first refresh rate, the predetermined voltage is set at a third voltage level during the anode reset operation; and
when the display pixel is configured to operate at the second refresh rate, the predetermined voltage is set at a fourth voltage level, greater than the third voltage level, during the anode reset operation.

11. A method of operating a display having an array of pixels, wherein each pixel in the array includes a light-emitting diode, an emission transistor, and a drive transistor coupled in series between the emission transistor and the light-emitting diode, the method comprising:
during a data programming phase, sequentially activating rows of pixels in the array to load data signals into the array;
during an emission phase, simultaneously activating the emission transistor in each pixel across the array; and
after the data programming phase and before the emission phase, performing a global anode reset operation to reset an anode of the light-emitting diode in each pixel across the array to a predetermined voltage level prior to the emission phase.

12. The method of claim 11, further comprising:
following the emission phase, performing an additional global anode reset operation to reset the anode of the light-emitting diode in each pixel across the array to a voltage level different than the predetermined voltage level after the emission phase.

13. The method of claim 11, wherein each pixel in the array further includes a select transistor that is activated during the data programming phase and an anode reset transistor that is activated during the global anode reset operation, the method further comprising:
during a global initialization phase, simultaneously activating the anode reset transistor and the select transistor in each pixel across the array; and
during a global compensation phase, simultaneously activating the select transistor and the emission transistor in each pixel across the array,
wherein the anode reset transistor in each pixel across the array is configured to receive a reset voltage set to:
the predetermined voltage level during the data programming phase and the global anode reset operation; and
an additional voltage level different than the predetermined voltage level during at least the global initialization phase.

14. The method of claim 11, wherein the light-emitting diode in each pixel across the array has a cathode terminal configured to receive a cathode voltage, the method further comprising:
during the emission phase, driving the cathode voltage to a first voltage level; and
during at least the data programming phase, suppressing leakage through the light-emitting diode in each pixel across the array by driving the cathode voltage to a second voltage level greater than the first voltage level.

15. The method of claim 11, wherein the display is configured to operate at a first refresh rate or a second refresh rate greater than the first refresh rate, the method further comprising:
while the display is operating at the first refresh rate, providing a first reset voltage to each pixel across the array during the global anode reset operation; and
while the display is operating at the second refresh, providing a second reset voltage, greater than the first reset voltage, to each pixel across the array during the global anode reset operation.

16. A display operable at a first refresh rate and a second refresh rate, comprising:
an array of pixels, wherein each pixel in the array includes a light-emitting diode, an emission transistor, a drive transistor coupled between the emission transistor and the light-emitting diode, a select transistor coupled to a gate terminal of the drive transistor, an anode reset transistor coupled to an anode of the light-emitting diode, a first capacitor coupled between the gate terminal of the drive transistor and the anode, and a second capacitor coupled between the anode and a voltage line on which a fixed voltage is provided, wherein:
when the display is configured to operate at the first refresh rate, the anode reset transistor is configured to receive, during a global anode reset operation, a reset voltage driven to a first voltage level; and
when the display is configured to operate at the second refresh rate, the anode reset transistor is configured to receive, during the global anode reset operation, the reset voltage driven to a second voltage level different than the first voltage level.

17. The display of claim 16, wherein:
the second refresh rate is greater than the first refresh rate; and
the second voltage level is at least 0.5 V greater than the first voltage level.

18. The display of claim 16, wherein:
the light-emitting diode in each pixel across the array has a cathode configured to receive a cathode voltage;
during an emission phase, the emission transistor in each pixel across the array is activated while the cathode voltage is driven to a third voltage level; and
during a data programming phase, the select transistor in each pixel across the array is activated while the cathode voltage is driven to a fourth voltage level greater than the third voltage level to suppress leakage through the light-emitting diode.

19. The display of claim 18, wherein the global anode reset operation is performed after the data programming phase and before the emission phase.

20. The display of claim 16, wherein:
during an additional global reset operation following the emission phase, the anode reset transistor is configured to receive the reset voltage driven to a third voltage level less than the first and second voltage levels.
